(19) United States
(12) Patent Application Publication
(10) Pub. No.: US 2008/0123653 A1
(43) Pub. Date: May 29, 2008

(54) NETWORK ACCESS CONTROL APPARATUS AND METHOD THEREFOR

(75) Inventors: SHIH-FANG WONG, Taipei Hsien (TW); YONG YUAN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzen City (CN); HON HAI PRECISION INDUSTRY CO., LTD, Taipei Hsien (TW)

(21) Appl. No.: 11/773,409

(22) Filed: Jul. 4, 2007

(30) Foreign Application Priority Data
Jul. 5, 2006 (CN) 200610061509.2

(51) Int. Cl. H04L 12/56

(52) U.S. Cl. 370/392

(57) ABSTRACT

A network access control method for controlling network access by utilizing a network access control apparatus is provided. The method includes: receiving an ID of a user; acquiring an access control list and an applying position according to the received ID; applying the acquired access control list at the applying position; extracting data packet information of data packets; and controlling the forwarding of the data packets according to the acquired access control list.

### BACKGROUND

1. Technical Field

The present invention relates to computer networks and particularly to network access control apparatus and method therefor.

2. General Background

Computer networks have become one of the most common ways for information exchange. Intermediate network devices, such as routers and switches, play an important role within the network. Not only do intermediate network devices transfer data packets, but also monitor and protects the network. One method of protection the network is to use an Access Control List (ACL). The intermediate devices extract data packet information, typically including a source address and a destination address, from received data packets, and utilize the ACL to decide whether the received data packets should be forwarded or dropped. An ACL can be applied to a port of an intermediate device, either in the inbound direction (available for data packets entering the port) or the outbound direction (available for data packets exiting the port). ACL may include one or more entries (entries 101-103 in FIG. 1), each entry is a criteria for comparing with the packet information of the data packets. If the data packet information matches a certain entry in an ACL, a corresponding action is taken (deny or permit the data packet to be forwarded), and the comparing process stops.

An ACL is managed and controlled by systems administrators or users with special privileges. Typically, a system admin or users with special privileges will remotely login to the intermediate device, and enter the commands to activate, make changes, or create a new ACL. For new or inexperienced users to ACL, entering commands can be complicated and time consuming. Further, if one computer is being used by more than one person with different access privileges, the ACL of the intermediate device may need to be updated because the ACL cannot differentiate between users. As such, the frequent use of one computer by many individuals will involve changing the ACL frequently, however, changing the ACL repeatedly is troublesome.

What is needed, therefore, is a network access control apparatus and method, through which the ACL can be easily applied.

### SUMMARY

A network access control apparatus is provided. The apparatus includes a plurality of interfaces, a receiver, a data storage and a microcontroller unit (MCU). The interfaces are each configured for connecting to a network device. The receiver is for receiving an ID of a user. The data storage is for storing access control list and a rule table. The access control list is for controlling forwarding of data packet. The rule table is for recording relationship among the ID, the access control list and applicable privileges. The MCU includes an applying module and a packet managing module. The applying module is for acquiring the access control list and the applying position from the rule table, and applying the acquired access control list at the applying position. The packet managing module is for extracting data packet information of the data packet, and controlling the forwarding of data packets according to the applied access control rule.

A network access control method for controlling network access by utilizing a network access control apparatus is provided. The method includes: receiving an ID of a user; acquiring an access control list and an applying position according to the received ID; applying the acquired access control list at the applying position; extracting data packet information of data packets; and controlling the forwarding of the data packets according to the acquired access control list.

Other advantages and novel features will be drawn from the following detailed description with reference to the attached drawing.

### BRIEF DESCRIPTION OF THE DRAWINGS

FIG. 1 is a table illustrating three access control lists;

FIG. 2 is a block diagram of a hardware infrastructure of a network access control apparatus;

FIG. 3 illustrates an exemplary rule table in accordance with the present invention; and

FIG. 4 is a flowchart of a preferred method for network access control, which is performed by the apparatus of FIG. 2.

### DETAILED DESCRIPTION OF THE EMBODIMENT

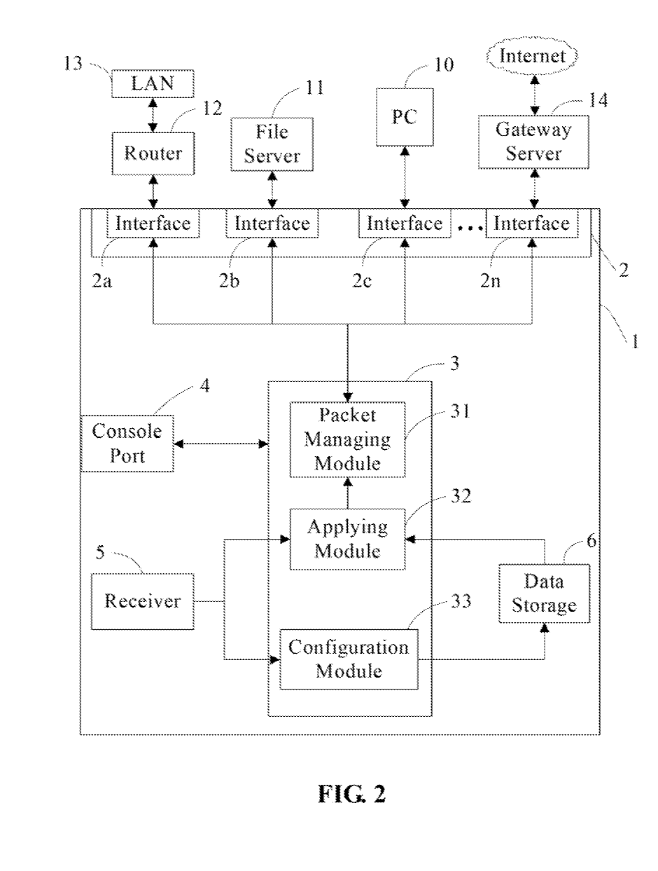

FIG. 2 is a block diagram of a hardware infrastructure of a network access control apparatus. The network access control apparatus 1 is an intermediate network device, typically a router or a switch, and configured for transferring data packets. The apparatus 1 includes a plurality of interfaces 2, a microcontroller unit (MCU) 3, a console port 4, a receiver 5, and a data storage 6. The interfaces 2 are configured for connecting to a network device, such as, a PC 10, a file server 11, a router 12 which connects to a LAN (local area network) 13, and a gateway server 14, and the interfaces 2 can be wired (e.g., RJ45) or wireless connections (e.g., IEEE 802.11). The receiver 5 is configured for receiving an ID of a user who needs to access the network devices connected to the apparatus 1. The ID can be an IC (integrated circuit) card or other means of identification, and the receiver is the input device for the ID.

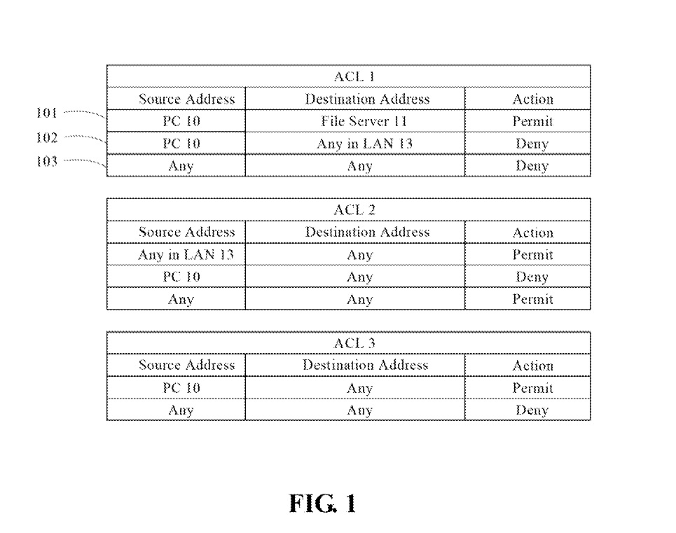

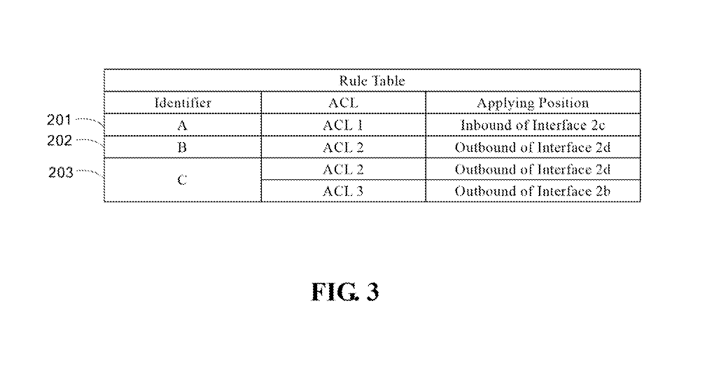

The data storage 6 is configured for storing at least one access control list (ACL) and a rule table (see FIGS. 1 and 3). The ACL is defined in a command-line interface by typing commands through login to the apparatus 1 remotely from a computer. The computer is connected to the apparatus 1 through the console port 4 which is a common used port on routers and switches for configuring functions of the routers and switches.

Each of the ACLs may include one or more entries (entries 101-103 in FIG. 1), each of the entries is a criteria for comparing data packet information (e.g., source address, destination address) of the data packet that is entering or exiting one of the interfaces 2. If the data packet information matches a certain entry in the ACL, a corresponding action is taken (deny the forwarding of data packets or permit the forwarding of data packets). In addition, each of the ACLs can be applied to one or more interfaces 2, either in the inbound direction or the outbound direction.

The rule table stored in the data storage 6 records IDs of users who need to access the network devices connected to the apparatus 1, one or more ACLs corresponding to each of the IDs, and applying positions where to apply each ACL. In other words, each record of the rule table records a relationship among user ID, ACL, and applying position.

The MCU includes a packet managing module 31, an applying module 32, and a configuration module 33. The applying module 32 is configured for acquiring the ACL and the applying position from the rule table according to the user ID received by the receiver 5, and applying the acquired ACL at the acquired applying position. For example, when the receiver 5 receives a user ID “A”, the applying module 32 acquires the ACL (i.e., ACL 1) and the applying position (i.e., inbound of interface 2c) associated with the user ID “A” from the rule table, and applies the ACL 1 at the inbound of the interface 2c, so user “A” logs in and is allocated corresponding access authorities according to the applied ACLs.

The packet managing module 31 is configured for extracting data packet information from the data packets, and controlling the data packet forwarding according to the applied ACLs. For example, once the ACL 1 is applied at the inbound of the interface 2c, the packet managing module 31 extracts the data packet information of the data that is entering from the interface 2c, and compares the extracted data packet information with each of the entries in ACL 1. If a data packet whose source address is PC 10 and destination address is file server 11, namely where the data packet information matches an entry 101 of ACL 1, the packet managing module 31 forwards the data packet according to an associated action (i.e., permit) listed in the record 101.

After the user finished using the network devices and logs out, the applied ACLs associated with the user ID need to be disabled. If the receiver 5 receives a logout signal, e.g., receives a logout command, or receives an IC card signal for the second time which means the user ID indicated by the IC card has already been allocated access authorities, the applying module 32 further disables the applied ACLs associated with the user ID that is already active.

The configuration module 33 is configured for providing an interface to be shown on a terminal connected to the apparatus 1 through the console port 4. The interface shows a list of the user IDs, a list of defined ACLs stored in the data storage 6, and a list of all the interfaces 2 of the apparatus 1, so an admin or users with special privileges of apparatus 1 can configure corresponding relationship among the user ID, the ACL, and the applying position through the interface. The configuration module 33 further stores the configured relationship into the rule table in the data storage 6.

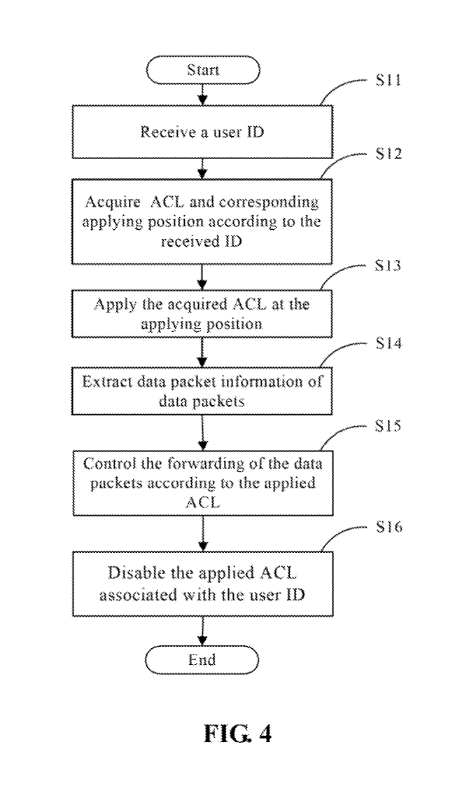

FIG. 4 is a flowchart of a preferred method for controlling network access, which is preformed by the network access control apparatus 1.

In step S11, the receiver 5 receives the user ID.

In step S12, the applying module 32 acquires the ACL and the corresponding applying position from the rule table according to the received user ID.

In step S13, the applying module 32 applies the acquired ACL to the acquired corresponding applying position.

In step S14, the packet managing module 31 extracts data packet information of the data packets.

In step S15, the packet managing module 31 controls the forwarding of data packets according to the acquired ACL.

In step S16, the applying module 32 disables the applied ACLs associated with the user ID while the receiver 5 receives a logout signal.

Therefore, by utilizing the apparatus 1, users who need to access the network devices connected to the apparatus 1, can readily enter an individual ID through using IC cards, to activate access authorities corresponding to the individual ID, without needing to type complicate applying commands to activate the ACL in the conventional command-line interface. In other words, this applying process combining the apparatus 1 and user IDs obviously simplifies users' operations.

Although the present invention has been specifically described on the basis of preferred embodiments and preferred methods thereof, the invention is not to be construed as being limited thereto. Various changes or modifications may be made to the embodiment and method without departing from the scope and spirit of the invention.

What is claimed is:

1. A network access control apparatus comprising:
a plurality of interfaces each configured for connecting to a network device;
a receiver configured for receiving an ID of a user who needs to access the network devices connected to the apparatus;
a data storage configured for storing at least one access control list and a rule table, the at least one access control list configured for controlling forwarding of data packet, and the rule table configured for recording relationship among the ID, the at least one access control list and at least one applying position which indicates where to apply the at least one access control list; and
a microcontroller unit (MCU), comprising:
an applying module configured for acquiring the at least one access control list and the at least one applying position from the rule table according to the received ID, and applying the acquired at least one access control list at the at least one applying position; and
a packet managing module configured for extracting data packet information of the data packet, and controlling the forwarding of data packets according to the applied access control list.

2. The apparatus according to claim 1, wherein the MCU further comprises a configuration module configured for configuring the corresponding relationship among the identifier, the at least one access control list, and the at least one applying position.

3. The apparatus according to claim 1, wherein the applying module further disables the applied ACLs associated with the user ID while the receiver receives a logout signal.

4. The apparatus according to claim 3, wherein the logout signal is receiving the user ID for the second time.

5. A network access control method for controlling network access by utilizing a network access control apparatus, wherein the apparatus stores at least one access control list and a rule table, the at least one access control list is configured for controlling forwarding of data packets, and the rule table is configured for recording relationship among an ID of a user, the at least one access control list and at least one applying position which indicates where to apply the at least one access control list, the method comprising:
receiving the ID of the user;
acquiring the at least one access control list and the at least one applying position according to the received ID;
applying the acquired at least one access control list at the at least one applying position;
extracting data packet information of the data packets; and
controlling forwarding of the data packets according to the acquired access control list.

6. The method according to claim 5, further comprising:
configuring the corresponding relationship among the ID, the at least one access control list and the at least one applying position.

7. The method according to claim 5, further comprising:
disables the applied ACLs associated with the user ID while receives a logout signal.

8. The method according to claim 7, wherein the logout signal is receiving the user ID for the second time.
